(19) United States
(12) Patent Application Publication
(10) Pub. No.: US 2024/0362823 A1
(43) Pub. Date: Oct. 31, 2024

(54) ENCODING METHOD AND DECODING METHOD

(71) Applicant: GUANGDONG OPPO MOBILE TELECOMMUNICATIONS CORP., LTD., Dongguan (CN)

(72) Inventors: Fuzheng YANG, Dongguan (CN); Junyan HUO, Dongguan (CN); Ming LI, Dongguan (CN)

(21) Appl. No.: 18/768,273

(22) Filed: Jul. 10, 2024

Related U.S. Application Data
(63) Continuation of application No. PCT/CN2022/071468, filed on Jan. 11, 2022.

(51) Int. Cl. G06T 9/00

(52) U.S. Cl. CPC G06T 9/00

(57) ABSTRACT

An encoding method and a decoding method are provided. The encoding method includes the following. A tree structure for geometry information of a point cloud is obtained, where the tree structure has at least two node-layers, and each of the at least two node-layers includes at least one node. Planar-encoding-mode eligibility corresponding to a first node-layer of the tree structure is determined. Whether a first node in the first node-layer is encoded using a planar encoding mode is determined according to the planar-encoding-mode eligibility.

### CROSS-REFERENCE TO RELATED APPLICATION(S)

This application is a continuation of International Application No. PCT/CN2022/071468, filed Jan. 11, 2022, the entire disclosure of which is hereby incorporated by reference.

### TECHNICAL FIELD

Embodiments of the disclosure relate to the technical field of point cloud coding, and more specifically to an encoding method and a decoding method.

### BACKGROUND

With the continuous development of point cloud technology, compression encoding of point cloud data becomes an important research problem. At present, both the audio video coding standard workgroup of China (AVS) and the moving picture experts group (MPEG) of international standardization organization (ISO) are developing point cloud coding standards, such as geometry-based point cloud compression (G-PCC). How to further improve performance of point cloud coding is an urgent problem to be solved.

### SUMMARY

In a first aspect, an encoding method is provided. The method includes the following. A tree structure for geometry information of a point cloud is obtained, where the tree structure has at least two node-layers, and each of the at least two node-layers includes at least one node. Planar-encoding-mode eligibility corresponding to a first node-layer of the tree structure is determined. Whether a first node in the first node-layer is encoded using a planar encoding mode is determined according to the planar-encoding-mode eligibility.

In a second aspect, a decoding method is provided. The method includes the following. A tree structure for geometry information of a point cloud is obtained, where the tree structure has at least two node-layers, and each of the at least two node-layers includes at least one node. Planar-decoding-mode eligibility corresponding to a first node-layer of the tree structure is determined. Whether a first node in the first node-layer is decoded using a planar decoding mode is determined according to the planar-decoding-mode eligibility.

### BRIEF DESCRIPTION OF THE DRAWINGS

FIG. 1 is a schematic diagram of an octree structure in embodiments of the disclosure.

FIG. 2 is a schematic diagram illustrating octree partitioning in embodiments of the disclosure.

FIG. 3 is a schematic diagram of an encoder in embodiments of the disclosure.

FIG. 4 is a schematic diagram of a decoder in embodiments of the disclosure.

FIG. 5 is a schematic flowchart of an encoding method provided in embodiments of the disclosure.

FIG. 6 is a schematic flowchart of a decoding method provided in embodiments of the disclosure.

FIG. 7 is a schematic flowchart of another encoding method provided in embodiments of the disclosure.

FIG. 8 is a schematic flowchart of another decoding method provided in embodiments of the disclosure.

FIG. 9 is a schematic block diagram of an encoder provided in embodiments of the disclosure.

FIG. 10 is a schematic block diagram of a decoder provided in embodiments of the disclosure.

FIG. 11 is a schematic block diagram of an electronic device provided in embodiments of the disclosure.

### DETAILED DESCRIPTION

The following will describe technical solutions of embodiments of the disclosure with reference to the accompanying drawings in embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

This disclosure is applicable to the technical field of point cloud data compression.

Firstly, related terms in embodiments of the disclosure will be explained.
1) Point cloud, which is a three-dimensional (3D) representation of a surface of an object and refers to a collection of massive amounts of 3D points. Each point has associated attributes, such as colour, material properties, etc. Exemplarily, point clouds can be used to reconstruct an object or a scene as a composition of points. A point in the point cloud may have both geometry information and attribute information of the point. As an example, the geometry information of the point may be 3D coordinate information of the point, which may be represented by, for example, (x, y, z) in the Cartesian coordinate system or any coordinate system. The geometry information of the point may also be referred to as location information of the point. As an example, these points may have associated attribute information such as colour, for example, three component values of red-green-blue (RGB) or luminance-chrominance (YUV). Other attribute information may include transparency, reflectance, a normal vector, etc., which is not limited herein.

The point cloud may be static or dynamic. For example, static point cloud data may be generated by a detailed scan or mapping of an object or topography, and dynamic point cloud data may be generated by scanning an environment for machine-vision purposes. Since the dynamic point cloud data changes over time, the dynamic point cloud may be a time-ordered sequence of point clouds.

Point cloud data can be applied to various fields, such as virtual/augmented reality, machine vision, geographic information systems, medical fields, and the like. The point cloud of the surface of the object can be captured by a capturing equipment such as a photoelectric radar, LIDAR, a laser scanner, and a multi-view camera. The point cloud contains a large number of points, for example, billions of points, and thus the original data volume of the point cloud is particularly enormous. Therefore, an effective compression technology, i.e., encoding and decoding process, is required to reduce the data volume of the point cloud.
2) Tree structure for the point cloud, which may represent a partition result of geometry information of the point cloud during encoding or decoding of the point cloud. In the tree structure-based point cloud partition process, a volumetric space for the point cloud is recursively split into sub-volumes, accordingly, the volumetric space corresponds to a root node of the tree structure, and the sub-volumes correspond to nodes of the tree structure respectively. Exemplarily, whether to further split a sub-volume may be determined based on whether the sub-volume contains a point. Each node may have an occupancy bit which indicates whether a sub-volume corresponding to that node contains a point. Optionally, arithmetic encoding may be performed on these occupancy bits to obtain a binary bitstream.

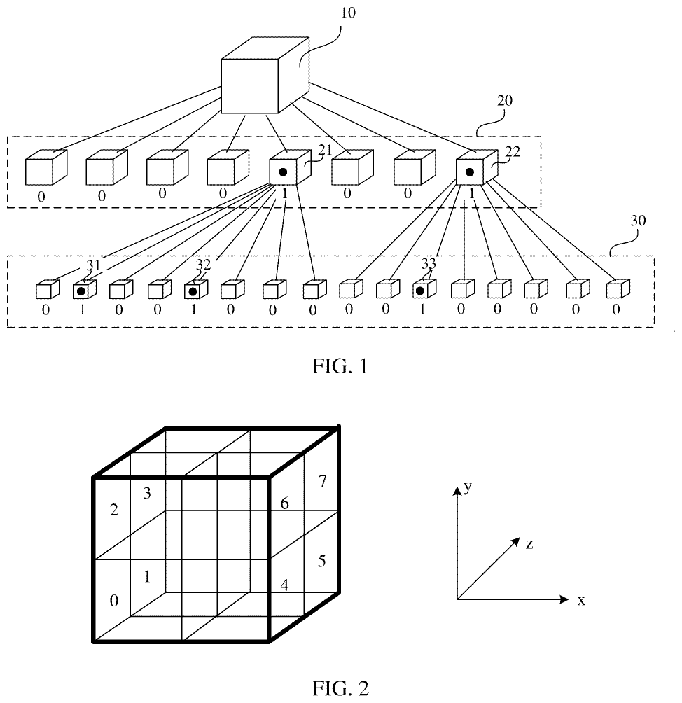

As an example, the tree structure may be an octree. In the octree structure for the point cloud, the volumetric space or sub-volumes are all cubes, and each split results in eight further sub-volumes/sub-cubes. FIG. 1 is a schematic diagram of an octree structure. As illustrated in FIG. 1, a node 10 may be a root node and may correspond to a volumetric space, for example, a cube, of a complete point cloud. The volumetric space corresponding to the node 10 may be split into 8 sub-volumes, each of which corresponds to one of nodes in the dashed box 20. The node 10 is a parent node of the nodes in the dashed box 20, accordingly, the nodes in the dashed box 20 are child nodes of the node 10, and the child nodes may be called sibling nodes of each other. As illustrated in FIG. 1, the child nodes of the node 10 (i.e., the nodes in the dashed box 20) may include a node containing a point, and an occupancy bit of the node is 1, which indicates that a sub-volume corresponding to that node contains a point. In some embodiments, a node whose occupancy bit is 1 may also be referred to as an occupied node, which is not limited in the disclosure. The child nodes of the node 10 may further include a node containing no point, and an occupancy bit of the node is 0, which indicates that a sub-volume corresponding to that node contains no point, i.e., the sub-volume is empty. The parent node may be represented by occupancy bits of its child nodes. For example, the node 10 may be represented by “00001001” in a binary form, which indicates that the occupancy bits of child node 21 and child node 22 are 1.

Exemplarily, a sub-volume corresponding to each of nodes whose occupancy bits are 1 in the dashed box 20, such as node 21 and node 22, may be split into 8 further sub-volumes. Correspondingly, the node 21 is a parent node of nodes corresponding to the 8 further sub-volumes that are split from the sub-volume corresponding to the node 21, and the node 22 is a parent node of nodes corresponding to the 8 further sub-volumes that are split from the sub-volume corresponding to the node 22. The 8 further sub-volumes obtained by splitting are child nodes, for example, respective nodes in the dashed box 30. Similarly, the node 21 may be represented by “01001000” in a binary form, which indicates that the occupancy bits of child node 31 and child node 32 are 1. The node 22 may be represented by “001000000” in a binary form, which indicates that the occupancy bit of child node 33 is 1. Optionally, arithmetic encoding may be performed on these occupancy bits to obtain a binary bitstream.

In some optional embodiments, the node 10 may also be a node corresponding to a sub-volume, that is, the octree structure in FIG. 1 may be a part of the octree structure corresponding to the complete point cloud, which is not limited in the disclosure.

In some optional embodiments, nodes having the same depth in the octree structure may form one node-layer. The octree structure may have at least two node-layers, each node-layer may include at least one node, and each node may correspond to one sub-volume.

As an example, as illustrated in FIG. 1, when the node 10 is the root node, all the nodes in the dashed box 20 have a depth value of 1 and belong to one node-layer, where the node-layer may be referred to as “layer” for short. Exemplarily, the node-layer corresponding to the dashed box 20 may be the 0-th layer of the octree structure. Similarly, all the nodes in the dashed box 30 have a depth value of 2 and belong to one node-layer. Exemplarily, the node-layer corresponding to the dashed box 30 may be the 1st layer of the octree structure. When sub-volumes corresponding to the nodes in the dashed box 30 are further split, the octree structure may have nodes of greater depths, which correspond to more node-layers. With an increase in the depth value of nodes, a layer number of a node-layer increases successively.

3) Context modelling, by which context information corresponding to each node of the octree structure can be obtained. FIG. 2 is a schematic diagram of spatial locations of 8 child nodes (i.e., child nodes 0 to 7), which are generated by octree partitioning, relative to their parent node (i.e., a current node). When an 8-bit spatial occupancy code is encoded for the current node, reference information of neighbours in the same layer can be obtained, for example, including occupancy information of neighbouring child nodes in the left, front, and downward directions (such as negative directions of x, y, and z axes in the coordinate system). Exemplarily, for each of child nodes at different locations of the current node, at least one of three coplanar neighbours, three collinear neighbours, or one co-vertex neighbour in the same layer as the child node may be used as a reference node. For a to-be-encoded node, occupancy status of reference nodes in the same layer as the to-be-encoded node may each correspond to one context information.

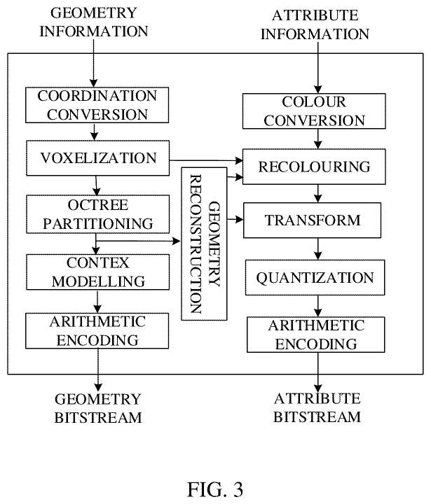

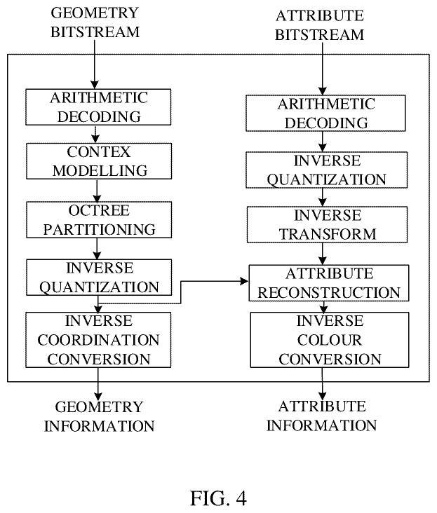

A coding framework for point cloud compression to which embodiments of the disclosure are applicable is described below with reference to FIG. 3 and FIG. 4.

FIG. 3 is a schematic block diagram of an encoder 100 provided in embodiments of the disclosure. Exemplarily, the encoder 100 may be a geometry-based point cloud compression (G-PCC) encoder. The input to the encoder 100 includes geometry information and attribute information of a point cloud. Exemplarily, the input point cloud is partitioned into slices, and then each obtained slice is encoded independently. In a slice, the geometry information and the attribute information of the point cloud are encoded separately. As illustrated in FIG. 3, the encoder 100 performs coordinate conversion on the geometry information such that the whole point cloud is contained in a bounding box. The bounding box may be referred to as a volumetric space corresponding to the point cloud. Then, the encoder performs voxelization, for example, including quantization and removing duplicate points. The quantization is to scale a result of coordinate conversion. Due to rounding in the quantization, some of the points have the same geometry information. In this case, whether to remove duplicate points may be determined according to parameters. Next, the encoder performs octree partitioning on the bounding box. Depending on the depth of the octree partitioning, encoding of the geometry information may be octree-based encoding or triangle soup (trisoup)-based encoding.

In the octree-based encoding process, the bounding box is octeted into 8 sub-cubes and occupancy bits of the sub-cubes are recorded. An occupancy bit of a sub-cube being 1 indicates that the sub-cube is non-empty, and in other words, the sub-cube is occupied by a point(s) in the point cloud, i.e., the sub-cube contains a point(s) in the point cloud. An occupancy bit of a sub-cube being 0 indicates that the sub-cube is empty, and in other words, the sub-cube is not occupied by any point in the point cloud, i.e., the sub-cube does not contain any point in the point cloud. Further, the non-empty sub-cubes continue to be octeted, for example, until a resulting leaf node is a 1×1×1 unit cube.

Exemplarily, a sub-cube may be referred to as a sub-volume, which means that it is split from the bounding box or the volumetric space. In this octree, the bounding box may be referred to as a root node, and each sub-cube may be referred to as a child node of the root node.

In the octree partitioning process, spatial correlation between a node and the surrounding nodes can be used for intra prediction of the occupancy bits. Then, context modelling is performed to obtain context information of the node. Finally, arithmetic encoding (such as adaptive binary arithmetic coding) is performed based on the context information, so as to generate a binary bitstream, i.e., a geometry bitstream.

In the trisoup-based encoding process, octree partitioning is also performed. Different from the octree-based encoding process, in the trisoup-based encoding process, instead of partitioning the point cloud layer-by-layer into 1×1×1 unit cubes, the partitioning is stopped when a side length of a block is W. Based on a surface formed by distribution of the point cloud in each block, up to 12 vertexes generated between the 12 edges of the block and the surface are obtained. Then, coordinates of the vertexes of each block are encoded in sequence to generate a binary bitstream, i.e. a geometry bitstream.

After finishing encoding of the geometry information, the G-PCC encoder reconstructs the geometry information and uses the reconstructed geometry information to encode the attribute information of the point cloud. Exemplarily, encoding of the attribute information of the point cloud is focused on encoding of colour information of points in the point cloud. First, the encoder may perform colour conversion on the colour information of the points. For example, when the colour information of the points in the input point cloud is represented using the RGB colour space, the encoder may convert the colour information from the RGB colour space to the YUV colour space. The reconstructed geometry information is then used to recolour the point cloud, so as to make the uncoded attribute information correspond to the reconstructed geometry information. Next, the colour information is transformed. Exemplarily, there are two transformation methods, that is, a distance-based lifting transform that relies on level of detail (LOD) partitioning and a direct region adaptive hierarchal transform (RAHT), both of which transform the colour information from the spatial domain to the frequency domain to obtain high-frequency coefficients and low-frequency coefficients, and finally quantize and arithmetically encode the coefficients to generate a binary bitstream, that is, an attribute bitstream.

Optionally, during encoding of the attribute information, the point cloud may be sorted according to Morton codes. Further, a geometric spatial relationship is used to search for a nearest neighbour(s) of a to-be-encoded point (also referred to as a to-be-predicted point), and a reconstructed attribute value of the found neighbour(s) is used for interpolation prediction on the to-be-encoded point to obtain a prediction attribute value. Then, a difference between the real attribute value and the prediction attribute value is calculated to obtain a prediction residual. Finally, quantization and arithmetic encoding are performed on the prediction residual, so as to obtain a binary bitstream.

FIG. 4 is a schematic block diagram of a decoder 200 provided in embodiments of the disclosure. The input to the decoder 200 includes a geometry bitstream and an attribute bitstream of a point cloud, where the geometry bitstream and the attribute bitstream of the point cloud are decoded separately. As illustrated in FIG. 4, the decoder 200 performs processes including arithmetic decoding, context modelling, octree partitioning, inverse quantization, and inverse coordinate conversion on the input geometry bitstream to obtain geometry information. The decoder 200 performs arithmetic decoding, inverse quantization, inverse transform, attribute reconstruction, and inverse colour conversion on the input attribute bitstream to obtain attribute information. Specifically, the decoding process is reciprocal to the encoding process.

During the context modelling involved in point cloud coding, whether a current node is eligible to be coded using a planar coding mode may be determined according to context information of the node. In the related solution, it may be determined that the current node is eligible for planar coding when the following two conditions are satisfied.
1. A local occupancy density of the node is greater than a preset threshold.
2. A proportion of nodes for which the planar coding mode in a certain direction (x-axis, y-axis, or z-axis) has been used is greater than a corresponding preset threshold. For example, three directions i.e. the x-axis direction, the y-axis direction, and the z-axis direction each correspond to one threshold.

For each node of the octree, two variables, namely the local occupancy density of the node of the octree structure and the proportion of nodes for which the planar coding mode in a certain direction (x-axis, y-axis, or z-axis) has been used, are updated in real time.

For example, the local occupancy density of the node may be updated according to the number of occupied nodes (numSibling) in a parent node of the node, i.e., the number of occupied nodes among 8 nodes that include the other 7 sibling nodes of the node and the node itself. The specific formula may be as follows.

$$OccupancyDensity = ( 255 * OccupancyDensity + 1024 * numSiblings + 128 ) >> 8$$

In the above, OccupancyDensity on the left side of the equation represents the updated local occupancy density of the current node. OccupancyDensity on the right side of the equation represents the local occupancy density of the current node before the update, for example, the local occupancy density of the previous node after the real-time update.

Therefore, updating of the two variables, namely the local occupancy density of the node of the octree structure and the proportion of nodes for which the planar coding mode in a certain direction (x-axis, y-axis, or z-axis) has been used, brings about great computation complexity. In addition, 4 thresholds are set for the above two conditions, which further increases computation difficulty and leads to relatively low coding gains.

In view of this, an encoding method is provided in embodiments of the disclosure, in which planar-encoding-mode eligibility corresponding to a node-layer of the tree structure for the geometry information of the point cloud is determined, and whether a node (such as a first node) in the node-layer is encoded using a planar encoding mode is determined according to the planar-encoding-mode eligibility corresponding to the node-layer. In embodiments of the disclosure, by determining planar-encoding-mode eligibility corresponding to a node-layer of the tree structure corresponding to the geometry information of the point cloud, the planar-encoding-mode eligibility does not need to be determined for each node of the tree structure, thereby reducing computation complexity of encoding and also improving encoding gains.

Further, a decoding method is provided in embodiments of the disclosure. Specifically, corresponding to the above encoding method, planar-decoding-mode eligibility corresponding to a node-layer of the tree structure for the geometry information of the point cloud is determined, and whether a node (such as a first node) in the node-layer is decoded using a planar decoding mode is determined according to the planar-decoding-mode eligibility corresponding to the node-layer. In embodiments of the disclosure, by determining planar-decoding-mode eligibility corresponding to a node-layer of the tree structure corresponding to the geometry information of the point cloud, the planar-decoding-mode eligibility does not need to be determined for each node of the tree structure, thereby reducing computation complexity of decoding and also improving decoding gains.

A coding solution provided in embodiments of the disclosure will be described in detail below in conjunction with the accompanying drawings.

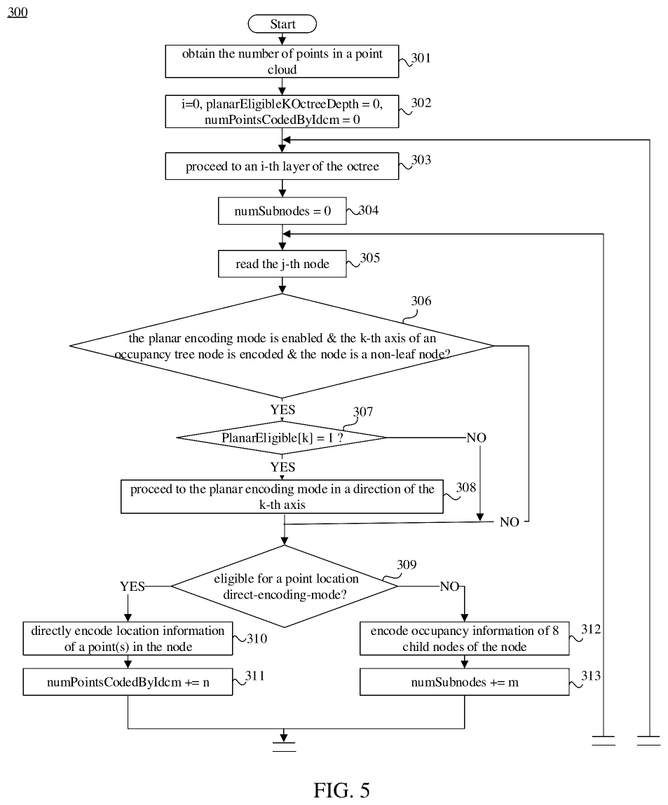

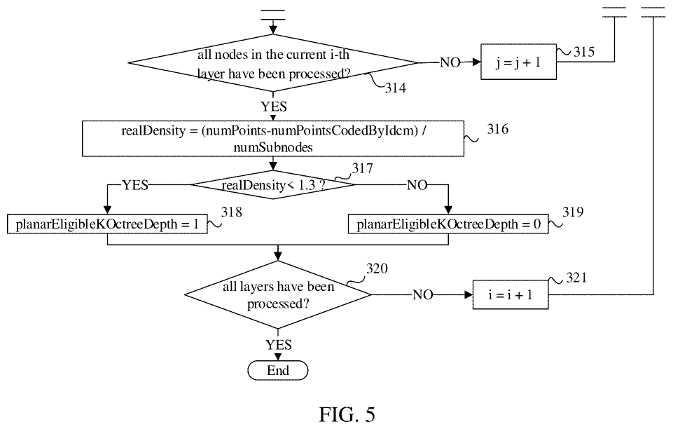

FIG. 5 is a schematic flowchart of an encoding method 300 provided in embodiments of the disclosure. The encoding method 300 is applicable to the encoder 100 illustrated in FIG. 3. For example, geometry information and attribute information of a point cloud may be input into the encoder 100, and thus compression encoding of the point cloud can be realized. As illustrated in FIG. 5, the method 300 includes operations at 301 to 321.

It may be understood that, FIG. 5 illustrates steps or operations of the encoding method, but these steps or operations are merely exemplary. Other operations or various modifications of respective operations in FIG. 5 can be implemented in embodiments of the disclosure. In addition, each step in FIG. 5 may be executed in an order different from that illustrated in FIG. 5, and not all the operations illustrated in FIG. 5 may be executed.

At 301, obtain the number of points in a point cloud.

In some embodiments, during obtaining the point cloud or before compression encoding of the point cloud, the number of points in the point cloud, i.e., the number of all points contained in the point cloud, may be obtained. Exemplarily, the number of points in the point cloud may be represented by numPoints.

In embodiments of the disclosure, a tree structure for geometry information of the point cloud, such as an octree structure, may be obtained. The tree structure may have at least two node-layers, and each node-layer may include at least one node.

Exemplarily, a volumetric space corresponding to the point cloud is split to obtain the tree structure, where the volumetric space corresponds to a root node of the tree structure, and sub-volumes split from the volumetric space correspond to nodes of the tree structure. Specifically, for the tree structure, reference can be made to the description of FIG. 1 and FIG. 2, which will not be repeated herein.

Exemplarily, the encoder 100 performs coordinate conversion, voxelization, and octree partitioning on the geometry information of the point cloud, and accordingly the octree structure for the geometry information of the point cloud can be obtained. The octree structure may have at least one node-layer, for example, the 0-th layer, the 1st layer . . . , and the M-th layer in sequence, where M is a positive integer greater than 1.

It may be noted that, the octree structure may correspond to a tree structure obtained by octree partitioning in the octree-based encoding process, and may also correspond to a tree structure obtained by octree partitioning in the trisoup-based encoding process, which is not limited in the disclosure.

At 302, i=0, planarEligibleKOctreeDepth=0, numPointsCodedByIdcm=0.

In the above, i represents a layer number of a current encoding node-layer (also referred to as a to-be-encoded node-layer) of the octree structure, planarEligibleKOctreeDepth represents planar-encoding-mode eligibility for the current encoding node-layer of the octree structure, and numPointsCodedByIdem represents the number of points that are encoded using a point location direct-encoding-mode in the point cloud. Exemplarily, a storage apparatus (such as a memory) of an encoding system such as the encoder 100 may store values of planarEligibleKOctreeDepth and numPointsCodedByIdcm, and update and maintain the values of planarEligibleKOctreeDepth and numPointsCodedByIdem according to the encoding of each layer.

That is to say, for i=0, i.e., when the (i=0)-th layer of the octree structure is to be encoded, planarEligibleKOctreeDepth may be initialized as 0, and numPointsCodedByIdem may be initialized as 0. Here, planarEligibleKOctreeDepth being initialized as 0 indicates that the planar-encoding-mode eligibility corresponding to the (i=0)-th node-layer is 0, that is, nodes (such as all nodes) in the (i=0)-th node-layer are not encoded using the planar encoding mode.

At 303, proceed to an i-th layer of the octree, where 0≤i≤M, and i is an integer.

In some optional embodiments, after operations at 302 are executed, operations at 303 may be executed. In this case, i=0, i.e., proceed to encoding of the 0-th layer of the octree.

In some optional embodiments, after operations at 321 are executed, the operations at 303 may be executed. In this case, 0<i≤M, i.e., after encoding of one node-layer, proceed to encoding of a next node-layer of the node-layer.

At 304, numSubnodes=0.

Here, numSubnodes represents the number of child nodes generated from nodes (such as all nodes) in the i-th layer. It may be noted that, upon proceeding to the i-th layer of the octree, initialize numSubnodes=0.

At 305, read the j-th node, where 0≤j≤X, i is an integer, X represents the number of nodes in the i-th layer, and X is a positive integer.

At 306, the planar encoding mode is enabled & the k-th axis of an occupancy tree node is encoded & the node is a non-leaf node?

That is, it is determined whether the j-th node satisfies the three conditions that the planar encoding mode is enabled, the k-th axis of the occupancy tree node is encoded, and the node is a non-leaf node.

Exemplarily, in a 3D coordinate system, k=0, 1, or 2. For example, when k=0, the k-th axis is the x-axis. When k=1, the k-th axis is the y-axis. When k=2, the k-th axis is the z-axis.

When it is determined that the j-th node satisfies the three conditions that the planar encoding mode is enabled, the k-th axis of the occupancy tree node is encoded, and the node is a non-leaf node, operations at 307 are executed next. When it is determined that the j-th node does not satisfy at least one of the conditions that the planar encoding mode is enabled, the k-th axis of the occupancy tree node is encoded, and the node is a non-leaf node, operations at 309 are executed next.

It may be noted that, at 306, whether the j-th node satisfies the three conditions that the planar encoding mode is enabled, the k-th axis of the occupancy tree node is encoded, and the node is a non-leaf node is taken as an example for illustration, but embodiments of the disclosure are not limited thereto. For example, in some embodiments, it may also be determined whether the j-th node satisfies at least one of the three conditions or other conditions, which is not limited in the disclosure.

At 307, PlanarEligible [k]=1?

Specifically, it may be further determined whether planarEligibleKOctreeDepth is 1. When planarEligibleKOctreeDepth=1, PlanarEligible [k]=1, and when planarEligibleKOctreeDepth=0, PlanarEligible [k]=0. In the above, PlanarEligible [k] represents planar-encoding-mode eligibility of the current node (i.e., the j-th node) in a direction of the k-th axis. Exemplarily, the planar-encoding-mode eligibility of the node may indicate whether the node can be encoded using the planar encoding mode. For example, when the planar-encoding-mode eligibility is 1, the node can be encoded using the planar encoding mode. When the planar-encoding-mode eligibility is 0, the node cannot be encoded using the planar encoding mode.

In some optional embodiments, a current value of planarEligibleKOctreeDepth may be obtained by reading from the memory of the encoding system such as the encoder 100, which is not limited in the disclosure.

In some optional embodiments, during encoding of the (i=0)-th node-layer, since planarEligibleKOctreeDepth has been initialized as 0, it can be determined that PlanarEligible [k]=0.

When PlanarEligible [k]=1, operations at 308 are executed next. When PlanarEligible [k]=0, operations at 309 are executed next.

At 308, proceed to the planar encoding mode in a direction of the k-th axis.

Specifically, in this case, the j-th node may be encoded using the planar encoding mode in the direction of the k-th axis.

At 309, eligible for a point location direct-encoding-mode?

In some optional embodiments, in a case where operations at 309 are executed after the operations at 308, the j-th node satisfies the three conditions that the planar encoding mode is enabled & the k-th axis of the occupancy tree node is encoded & the node is a non-leaf node, and planarEligibleKOctreeDepth corresponding to the i-th node-layer is 1. In this case, after the j-th node is encoded using the planar encoding mode, whether the j-th node is eligible for the point location direct-encoding-mode can be determined.

In some optional embodiments, in a case where the operations at 309 are executed after operations at 306 or 307, the j-th node does not satisfy at least one of the conditions that the planar encoding mode is enabled & the k-th axis of the occupancy tree node is encoded & the node is a non-leaf node, or planarEligibleKOctreeDepth corresponding to the i-th node-layer is 0. In this case, the j-th node is not encoded using the planar encoding mode, and whether the j-th node is eligible for the point location direct-encoding-mode can be determined.

When the node is eligible for the point location direct-encoding-mode, operations at 310 are executed next. When the node is not eligible for the point location direct-encoding-mode, operations at 312 are executed next.

At 310, directly encode location information of a point(s) in the node.

Exemplarily, the number of points in the j-th node is n, where n is a positive integer.

At 311, numPointsCodedByIdcm+=n, that is, accumulation update is performed on the value of numPointsCodedByIdcm according to the number n of points in the j-th node.

At 312, encode occupancy information of 8 child nodes of the node.

Exemplarily, when the j-th node is not encoded using the point location direct-encoding-mode, an occupancy bit encoding mode may be used for the node, that is, the occupancy information of the 8 child nodes of the node is encoded. Exemplarily, the number of occupied child nodes among the 8 child nodes is m, where m≤8 and m is a positive integer. Here, an occupied child node refers to a child node whose occupancy bit is non-empty (for example, 1).

At 313, numSubnodes+=m, that is, accumulation update is performed on the value of numSubnodes according to the number m of occupied child nodes among the 8 child nodes of the j-th node.

At 314, all nodes in the current i-th layer have been processed?

In a case where a node in the current i-th layer has not yet been processed, operations at 315 are executed. In a case where all nodes in the current i-th layer have been processed, operations at 316 are executed.

At 315, j=j+1.

After the operations at 315, the process proceeds to operations at 305 to read a next node, and performs operations at 305 to 313 on the next node.

In some embodiments, after multiple cycles of the operations at 305 to 313, all nodes in the i-th layer can be processed. In this case, accumulation update of the value of numSubnodes corresponding to the i-th layer can be realized.

At 316, realDensity=(numPoints-numPointsCodedByIdcm)/numSubnodes.

In the above, realDensity represents a real point cloud density of the (i+1)-th layer. In some embodiments, the real point cloud density may also be referred to as a point cloud density, which is not limited herein.

At 317, realDensity<1.3?

If the real point cloud density realDensity of the (i+1)-th layer is less than 1.3, then operations at 318 will be executed next. Otherwise, if the real point cloud density realDensity of the (i+1)-th layer is greater than or equal to 1.3, then operations at 318 will be executed next.

Here, 1.3 is an example of a preset threshold. Optionally, the preset threshold may be greater than or equal to 1. In some embodiments, the preset threshold may be less than a certain value, for example, less than 2, 3, or the like, which is not limited herein.

It may be noted that in embodiments of the disclosure, the preset threshold may be changed. For example, the preset threshold is adjusted to be smaller, so that a determining condition for the planar encoding mode is much stricter. Alternatively, the preset threshold is adjusted to be greater, so that the determining condition for the planar encoding mode is much looser.

At 318, planarEligibleKOctreeDepth=1.

That is to say, if the real point cloud density realDensity of the (i+1)-th layer is less than 1.3, the planar-encoding-mode eligibility corresponding to the (i+1)-th layer may be set to 1 (i.e., planarEligibleKOctreeDepth=1), that is, a node (such as each node) in the (i+1)-th layer satisfies planarEligibleKOctreeDepth=1.

It may be noted that, the real point cloud density realDensity of the (i+1)-th layer being less than 1.3 indicates that the average number of points in each node in the (i+1)-th layer is less than 1.3. In this case, in the (i+1)-th layer, the number of points in some nodes is less than 1.3, such as 1, and the number of points in other nodes is greater than or equal to 1.3, such as 2 or 3. It may be understood that, when the real point cloud density realDensity of the (i+1)-th layer is less than 1.3, it indicates that the number of points in most nodes in the (i+1)-th layer is 1. Those skilled in the art may appreciate that, when the number of points in a node is 1, only one of eight child nodes of the node is occupied by the point. That is, the one child node is located on the same plane in three coordinate axis directions, and thus the node can be encoded using the planar encoding mode. Therefore, the probability that nodes in the (i+1)-th layer are eligible for the planar encoding mode may be relatively high, so that planarEligibleKOctreeDepth of the (i+1)-th layer can be set to 1.

At 319, planarEligibleKOctreeDepth=0.

That is to say, if the real point cloud density realDensity of the (i+1)-th layer is greater than or equal to 1.3, the planar-encoding-mode eligibility corresponding to the (i+1)-th layer may be set to 0 (i.e., planarEligibleKOctreeDepth=0), that is, a node (such as each node) in the (i+1)-th layer satisfies planarEligibleKOctreeDepth=0.

It may be noted that, the real point cloud density realDensity of the (i+1)-th layer being greater than or equal to 1.3 indicates that the average number of points in each node in the (i+1)-th layer is greater than or equal to 1.3. In this case, in the (i+1)-th layer, the number of points in most nodes is greater than or equal to 1.3, such as 2, 3, 4 . . . , and the like, and the number of points in a few nodes may be less than 1.3, such as 1. It may be understood that, when the real point cloud density realDensity of the (i+1)-th layer is greater than or equal to 1.3, it indicates that the number of points in most nodes in the (i+1)-th layer is 2, 3, or 4. Those skilled in the art may appreciate that, when the number of points in a node is 3 or more, child nodes containing the 3 or more points are very likely to be not on the same plane, and thus the probability that the node is eligible for the planar encoding mode is relatively low. Therefore, the probability that each node in the (i+1)-th layer is eligible for the planar encoding mode may be relatively low, so that planarEligibleKOctreeDepth of the (i+1)-th layer can be set to 0.

In embodiments of the disclosure, according to a real point cloud density of a node-layer of an octree, planar-encoding-mode eligibility corresponding to the node-layer is determined, which can be conducive to more accurately determining whether all nodes in the node-layer are eligible for the planar encoding mode, thereby increasing encoding performance gains.

At 320, all layers have been processed?

After processing of the i-th layer, if there is still another layer that has not been processed, operations at 321 will be executed. When all layers have been processed, the process may end, that is, encoding of the point cloud is finished.

At 321, i=i+1.

After the operations at 321, the process proceeds to the operations at 303 to the (i+1)-th layer of the octree, that is, operations at 303 to 319 are performed on nodes in the next layer. In other words, the nodes in the next layer are encoded.

It may be noted that, when the process proceeds from the operations at 321 to the operations at 303 and continues to encoding of the nodes in the next layer, the next layer is regarded as the current encoding layer, i.e., the i-th layer. In this case, the current numSubnodes needs to be initialized, that is, numSubnodes is initialized as 0. In other words, during encoding of the current i-th layer, the number of child nodes generated from nodes in the current i-th layer is determined according to the encoding of the current i-th layer. That is to say, numSubnodes corresponds to the number of child nodes generated from the nodes in the current encoding node-layer.

It may be further noted that, when the process proceeds from the operations at 321 to the operations at 303, the value of numPointsCodedByIdcm remains unchanged. During execution of the operations at 303 to 319, the value of numPointsCodedByIdcm may be updated according to the encoding of each node in the current encoding node-layer. That is to say, numPointsCodedByIdcm corresponds to the number of points eligible for the point location direct-encoding-mode in the entire point cloud.

It may be further noted that, when the process proceeds from the operations at 321 to the operations at 303, the value of planarEligibleKOctreeDepth remains unchanged. During execution of the operations at 303 to 319, whether each node in the current encoding node-layer is encoded using the planar encoding mode may be determined according to the value of planarEligibleKOctreeDepth. In addition, the value of planarEligibleKOctreeDepth may be updated according to both numPointsCodedByIdem and numSubnodes corresponding to all processed nodes in the current encoding node-layer, that is, the value of planarEligibleKOctreeDepth corresponding to the next layer of the current encoding node-layer may be determined.

In some optional embodiments, the encoding end (such as the encoder) may transmit the number of points in the point cloud and related information of the octree structure, such as the number of layers and node information of each layer, to the decoding end (such as the decoder) together with the binary bitrate obtained through encoding. For example, the number of points in the point cloud and related information of the octree structure may be included in the header file for transmission, which is not limited in the disclosure.

Therefore, in embodiments of the disclosure, planar-encoding-mode eligibility corresponding to a node-layer of the tree structure for the geometry information of the point cloud is determined, and then whether a node (such as a first node) in the node-layer is encoded using the planar encoding mode is determined according to the planar-encoding-mode eligibility corresponding to the node-layer. In embodiments of the disclosure, by determining the planar-encoding-mode eligibility corresponding to the node-layer of the tree structure corresponding to the geometry information of the point cloud, the planar-encoding-mode eligibility does not need to be determined for each node of the tree structure, thereby reducing computation complexity of coding and also improving encoding gains.

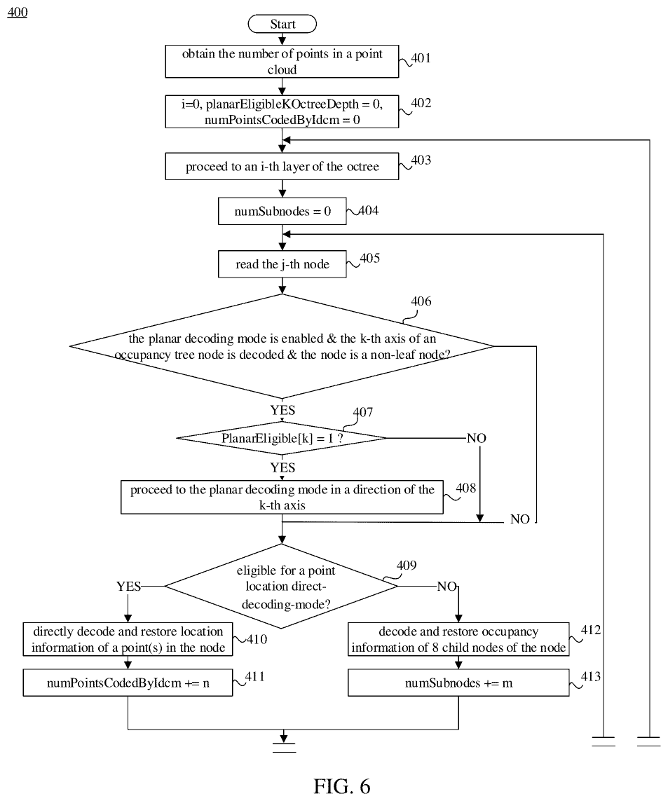

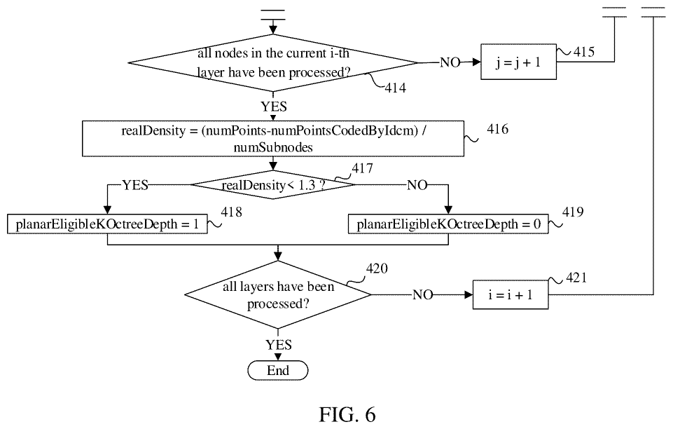

FIG. 6 is a schematic flowchart of a decoding method 400 provided in embodiments of the disclosure. The decoding method 400 is applicable to the decoder 200 illustrated in FIG. 4. For example, a geometry bitstream and attribute bitstream of a point cloud may be input into the decoder 200, and thus the point cloud can be decoded. As illustrated in FIG. 6, the method 400 includes operations at 401 to 421.

It may be understood that, FIG. 6 illustrates steps or operations of the decoding method, but these steps or operations are merely exemplary. Other operations or various modifications of respective operations in FIG. 6 can be implemented in embodiments of the disclosure. In addition, each step in FIG. 6 may be executed in an order different from that illustrated in FIG. 6, and not all the operations illustrated in FIG. 6 may be executed.

At 401, obtain the number of points in a point cloud.

In some embodiments, during obtaining the point cloud or before decoding of the point cloud, the number of points, numPoints, in the point cloud may be obtained.

In embodiments of the disclosure, related information of a tree structure, such as an octree structure, for geometry information of the point cloud may be obtained, and then the tree structure for the geometry information of the point cloud, such as the octree structure, may be obtained.

In some optional embodiments, the decoding end (such as the decoder) may obtain the number of points in the point cloud and related information of the octree structure, such as the number of layers and node information of each layer, which are transmitted by the encoding end (such as the encoder), and such information can be transmitted to the decoding end together with the binary bitrate. For example, the number of points in the point cloud and related information of the octree structure may be included in the header file for transmission, which is not limited in the disclosure.

Specifically, for the number of points in the point cloud and the octree structure, reference can be made to the description of operations at 301 in FIG. 5, which will not be repeated herein.

At 402, i=0, planarEligibleKOctreeDepth=0, numPointsCodedByIdcm=0.

In the above, i represents a layer number of a current decoding node-layer (also referred to as a to-be-decoded node-layer) of the octree structure, planarEligibleKOctreeDepth represents planar-decoding-mode eligibility for the current decoding node-layer of the octree structure, and numPointsCodedByIdcm represents the number of points that are decoded using a point location direct-decoding-mode in the point cloud. Exemplarily, a storage apparatus (such as a memory) of a decoding system such as the decoder 200 may store values of planarEligibleKOctreeDepth and numPointsCodedByIdcm, and update and maintain the values of planarEligibleKOctreeDepth and numPointsCodedByIdem according to the decoding of each layer.

That is to say, for i=0, i.e., when the (i=0)-th layer of the octree structure is to be decoded, planarEligibleKOctreeDepth may be initialized as 0, and numPointsCodedByIdem may be initialized as 0. Here, planarEligibleKOctreeDepth being initialized as 0 indicates that the planar-decoding-mode eligibility corresponding to the (i=0)-th node-layer is 0, that is, nodes (such as all nodes) in the (i=0)-th node-layer are not decoded using the planar decoding mode.

At 403, proceed to an i-th layer of the octree, where 0≤i≤M, and i is an integer.

In some optional embodiments, after operations at 402 are executed, operations at 403 may be executed. In this case, i=0, i.e., proceed to decoding of the 0-th layer of the octree.

In some optional embodiments, after operations at 421 are executed, the operations at 403 may be executed. In this case, 0<i≤M, i.e., after decoding of one node-layer, proceed to decoding of a next node-layer of the node-layer.

At 404, numSubnodes=0.

Here, numSubnodes represents the number of child nodes generated from nodes (such as all nodes) in the i-th layer. It may be noted that, upon proceeding to the i-th layer of the octree, initialize numSubnodes=0.

At 405, read the j-th node, where 0≤j≤X, i is an integer, X represents the number of nodes in the i-th layer, and X is a positive integer.

At 406, the planar decoding mode is enabled & the k-th axis of an occupancy tree node is decoded & the node is a non-leaf node?

That is, it is determined whether the j-th node satisfies the three conditions that the planar decoding mode is enabled, the k-th axis of the occupancy tree node is decoded, and the node is a non-leaf node.

When it is determined that the j-th node satisfies the three conditions that the planar decoding mode is enabled, the k-th axis of the occupancy tree node is decoded, and the node is a non-leaf node, operations at 407 are executed next. When it is determined that the j-th node does not satisfy at least one of the conditions that the planar decoding mode is enabled, the k-th axis of the occupancy tree node is decoded, and the node is a non-leaf node, operations at 409 are executed next.

It may be noted that, at 406, whether the j-th node satisfies the three conditions that the planar decoding mode is enabled, the k-th axis of the occupancy tree node is decoded, and the node is a non-leaf node is taken as an example for illustration, but embodiments of the disclosure are not limited thereto. For example, in some embodiments, it may also be determined whether the j-th node satisfies at least one of the three conditions or other conditions, which is not limited in the disclosure.

At 407, PlanarEligible [k]=1?

Specifically, it may be further determined whether planarEligibleKOctreeDepth is 1. When planarEligibleKOctreeDepth=1, PlanarEligible [k]=1, and when planarEligibleKOctreeDepth=0, PlanarEligible [k]=0. In the above, PlanarEligible [k] represents planar-decoding-mode eligibility of the current node (i.e., the j-th node) in a direction of the k-th axis. Exemplarily, the planar-decoding-mode eligibility of the node may indicate whether the node can be decoded using the planar decoding mode. For example, when the planar-decoding-mode eligibility is 1, the node can be decoded using the planar decoding mode. When the planar-decoding-mode eligibility is 0, the node cannot be decoded using the planar decoding mode.

In some optional embodiments, a current value of planarEligibleKOctreeDepth may be obtained by reading from the memory of the decoding system such as the decoder 200, which is not limited in the disclosure.

In some optional embodiments, during decoding of the (i=0)-th node-layer, since planarEligibleKOctreeDepth has been initialized as 0, it can be determined that PlanarEligible [k]=0.

When PlanarEligible [k]=1, operations at 408 are executed next. When PlanarEligible [k]=0, operations at 409 are executed next.

At 408, proceed to the planar decoding mode in a direction of the k-th axis.

Specifically, in this case, the j-th node may be decoded using the planar decoding mode in the direction of the k-th axis.

At 409, eligible for a point location direct-decoding-mode?

In some optional embodiments, in a case where operations at 409 are executed after the operations at 408, the j-th node satisfies the three conditions that the planar decoding mode is enabled & the k-th axis of the occupancy tree node is decoded & the node is a non-leaf node, and planarEligibleKOctreeDepth corresponding to the i-th node-layer is 1. In this case, after the j-th node is decoded using the planar decoding mode, whether the j-th node is eligible for the point location direct-decoding-mode can be determined.

In some optional embodiments, in a case where the operations at 409 are executed after operations at 406 or 407, the j-th node does not satisfy at least one of the conditions that the planar decoding mode is enabled & the k-th axis of the occupancy tree node is decoded & the node is a non-leaf node, or planarEligibleKOctreeDepth corresponding to the i-th node-layer is 0. In this case, the j-th node is not decoded using the planar decoding mode, and whether the j-th node is eligible for the point location direct-decoding-mode can be determined.

When the node is eligible for the point location direct-decoding-mode, operations at 410 are executed next. When the node is not eligible for the point location direct-decoding-mode, operations at 412 are executed next.

At 410, directly decode and restore location information of a point(s) in the node.

Exemplarily, the number of points in the j-th node is n, where n is a positive integer.

At 411, numPointsCodedByIdcm+=n, that is, accumulation update is performed on the value of numPointsCodedByIdcm according to the number n of points in the j-th node.

At 412, decode and restore occupancy information of 8 child nodes of the node.

Exemplarily, when the j-th node is not decoded using the point location direct-decoding-mode, an occupancy bit decoding mode may be used for the node, that is, the occupancy information of the 8 child nodes of the node is decoded. Exemplarily, the number of occupied child nodes among the 8 child nodes is m, where m≤8 and m is a positive integer. Here, an occupied child node refers to a child node whose occupancy bit is non-empty (for example, 1).

At 413, numSubnodes+=m, that is, accumulation update is performed on the value of numSubnodes according to the number m of occupied child nodes among the 8 child nodes of the j-th node.

At 414, all nodes in the current i-th layer have been processed?

In a case where a node in the current i-th layer has not yet been processed, operations at 415 are executed. In a case where all nodes in the current i-th layer have been processed, operations at 416 are executed.

At 415, j=j+1.

After the operations at 415, the process proceeds to operations at 405 to read a next node, and performs operations at 405 to 413 on the next node.

In some embodiments, after multiple cycles of the operations at 405 to 413, all nodes in the i-th layer can be processed. In this case, accumulation update of the value of numSubnodes corresponding to the i-th layer can be realized.

At 416, realDensity-(numPoints-numPointsCodedByIdcm)/numSubnodes.

In the above, realDensity represents a real point cloud density of the (i+1)-th layer. In some embodiments, the real point cloud density may also be referred to as a point cloud density, which is not limited herein.

At 417, realDensity<1.3?

If the real point cloud density realDensity of the (i+1)-th layer is less than 1.3, then operations at 418 will be executed next. Otherwise, if the real point cloud density realDensity of the (i+1)-th layer is greater than or equal to 1.3, then operations at 418 will be executed next.

Here, 1.3 is an example of a preset threshold. Optionally, the preset threshold may be greater than or equal to 1. In some embodiments, the preset threshold may be less than a certain value, for example, less than 2, 3, or the like, which is not limited herein.

It may be noted that in embodiments of the disclosure, the preset threshold may be changed. For example, the preset threshold is adjusted to be smaller, so that a determining condition for the planar decoding mode is much stricter. Alternatively, the preset threshold is adjusted to be greater, so that the determining condition for the planar decoding mode is much looser.

At 418, planarEligibleKOctreeDepth=1.

That is to say, if the real point cloud density realDensity of the (i+1)-th layer is less than 1.3, the planar-decoding-mode eligibility corresponding to the (i+1)-th layer may be set to 1 (i.e., planarEligibleKOctreeDepth=1), that is, a node (such as each node) in the (i+1)-th layer satisfies planarEligibleKOctreeDepth=1.

It may be noted that, the real point cloud density realDensity of the (i+1)-th layer being less than 1.3 indicates that the average number of points in each node in the (i+1)-th layer is less than 1.3. In this case, in the (i+1)-th layer, the number of points in some nodes is less than 1.3, such as 1, and the number of points in other nodes is greater than or equal to 1.3, such as 2 or 3. It may be understood that, when the real point cloud density realDensity of the (i+1)-th layer is less than 1.3, it indicates that the number of points in most nodes in the (i+1)-th layer is 1. Those skilled in the art may appreciate that, when the number of points in a node is 1, only one of eight child nodes of the node is occupied by the point. That is, the one child node is located on the same plane in three coordinate axis directions, and thus the node can be decoded using the planar decoding mode. Therefore, the probability that nodes in the (i+1)-th layer are eligible for the planar decoding mode may be relatively high, so that planarEligibleKOctreeDepth of the (i+1)-th layer can be set to 1.

At 419, planarEligibleKOctreeDepth=0.

That is to say, if the real point cloud density realDensity of the (i+1)-th layer is greater than or equal to 1.3. the planar-decoding-mode eligibility corresponding to the (i+1)-th layer may be set to 0 (i.e., planarEligibleKOctreeDepth=0), that is, a node (such as each node) in the (i+1)-th layer satisfies planarEligibleKOctreeDepth=0.

It may be noted that, the real point cloud density realDensity of the (i+1)-th layer being greater than or equal to 1.3 indicates that the average number of points in each node in the (i+1)-th layer is greater than or equal to 1.3. In this case, in the (i+1)-th layer, the number of points in most nodes is greater than or equal to 1.3, such as 2, 3, 4 . . . , and the like, and the number of points in a few nodes may be less than 1.3, such as 1. It may be understood that, when the real point cloud density realDensity of the (i+1)-th layer is greater than or equal to 1.3, it indicates that the number of points in most nodes in the (i+1)-th layer is 2, 3, or 4. Those skilled in the art may appreciate that, when the number of points in a node is 3 or more, child nodes containing the 3 or more points are very likely to be not on the same plane, and thus the probability that the node is eligible for the planar decoding mode is relatively low. Therefore, the probability that each node in the (i+1)-th layer is eligible for the planar decoding mode may be relatively low, so that planarEligibleKOctreeDepth of the (i+1)-th layer can be set to 0.

In embodiments of the disclosure, according to a real point cloud density of a node-layer of an octree, planar-decoding-mode eligibility corresponding to the node-layer is determined, which can be conducive to more accurately determining whether all nodes in the node-layer are eligible for the planar decoding mode, thereby increasing decoding performance gains.

At 420, all layers have been processed?

After processing of the i-th layer, if there is still another layer that has not been processed, operations at 421 will be executed. When all layers have been processed, the process may end, that is, decoding of the point cloud is finished.

At 421, i=i+1.

After the operations at 421, the process proceeds to the operations at 403 to the (i+1)-th layer of the octree, that is, operations at 403 to 419 are performed on nodes in the next layer. In other words, the nodes in the next layer are decoded.

It may be noted that, when the process proceeds from the operations at 421 to the operations at 403 and continues to decoding of the nodes in the next layer, the next layer is regarded as the current decoding layer, i.e., the i-th layer. In this case, the current numSubnodes needs to be initialized, that is, numSubnodes is initialized as 0. In other words, during decoding of the current i-th layer, the number of child nodes generated from nodes in the current i-th layer is determined according to the decoding of the current i-th layer. That is to say, numSubnodes corresponds to the number of child nodes generated from the nodes in the current decoding node-layer.

It may be further noted that, when the process proceeds from the operations at 421 to the operations at 403, the value of numPointsCodedByIdem remains unchanged. During execution of the operations at 403 to 419, the value of numPointsCodedByIdem may be updated according to the decoding of each node in the current decoding node-layer. That is to say, numPointsCodedByIdcm corresponds to the number of points eligible for the point location direct-decoding-mode in the entire point cloud.

It may be further noted that, when the process proceeds from the operations at 421 to the operations at 403, the value of planarEligibleKOctreeDepth remains unchanged. During execution of the operations at 403 to 419, whether each node in the current decoding node-layer is decoded using the planar decoding mode may be determined according to the value of planarEligibleKOctreeDepth. In addition, the value of planarEligibleKOctreeDepth may be updated according to both numPointsCodedByIdcm and numSubnodes corresponding to all processed nodes in the current decoding node-layer, that is, the value of planarEligibleKOctreeDepth corresponding to the next layer of the current decoding node-layer may be determined.

Therefore, in embodiments of the disclosure, planar-decoding-mode eligibility corresponding to a node-layer of the tree structure for the geometry information of the point cloud is determined, and then whether a node (such as a first node) in the node-layer is decoded using the planar decoding mode is determined according to the planar-decoding-mode eligibility corresponding to the node-layer. In embodiments of the disclosure, by determining the planar-decoding-mode eligibility corresponding to the node-layer of the tree structure corresponding to the geometry information of the point cloud, the planar-decoding-mode eligibility does not need to be determined for each node of the tree structure, thereby reducing computation complexity of coding and also improving decoding gains.

Table 1 and Table 2 each illustrate an example of the effect of the encoding method of embodiments of the disclosure compared with the related art. Test sequences may include multiple test picture sequences, such as Cat1-A average, Cat1-B average, Cat3-fused average, and Cat3-frame average, etc. There are two error computation methods for geometry coding bitrate (BD-rate), which output computation errors D1 and D2 respectively. D1 represents a point-to-point geometry information error between a point in an original point cloud and a corresponding point in a reconstructed point cloud, and D2 represents a point-to-plane geometry information error between a point in the reconstructed point cloud and a plane for a corresponding point in the original point cloud, where the plane is related to a normal vector of the corresponding point.

Table 1 illustrates BD-rates obtained in the encoding method provided in embodiments of the disclosure under lossy compression of geometry information. The BD-rate represents a coding-bitrate saving percentage of the encoding method of embodiments of the disclosure with respect to the related art, under the same coding quality, where a negative BD-rate represents saved coding bitrates and a positive BD-rate represents increased coding bitrates. As can be seen from Table 1, for most of the test sequences, the use of the encoding method of embodiments of the disclosure can save coding bitrates.

TABLE 1

Geometry BD-TotalRate (%)

| Test sequence | D1 | D2 |
|---|---|---|
| Cat1-A average | −0.1% | −0.1% |
| Cat1-B average | −0.3% | −0.3% |
| Cat3-fused average | 0.5% | 0.5% |
| Cat3-frame average | −0.7% | −0.7% |
| Overall average | −0.2% | −0.2% |

| | |
|---|---|
| Avg. Enc Time [%] | 97% |
| Avg. Dec Time [%] | 98% |

Table 2 illustrates bpip ratios obtained in the encoding method provided in embodiments of the disclosure under lossless compression of geometry information. The bpip ratio represents the percentage of the coding bitrate of the embodiments of the disclosure in the coding bitrate of the related art, with no loss of point cloud quality, where the lower the numerical value of bpip ratio, the greater the bitrate savings in the encoding method of the embodiments of the disclosure. As can be seen from Table 2, for most of the test sequences, the use of the encoding method of embodiments of the disclosure can save coding bitrates.

TABLE 2

| | Geometry bpip ratio (%) |
|---|---|
| Test sequence | D1 |
| Cat1-A average | 97.2% |
| Cat1-B average | 99.8% |
| Cat3-fused average | 100.8% |
| Cat3-frame average | 99.9% |
| Overall average | 99.6% |
| Avg. Enc Time [%] | 95% |
| Avg. Dec Time [%] | 94% |

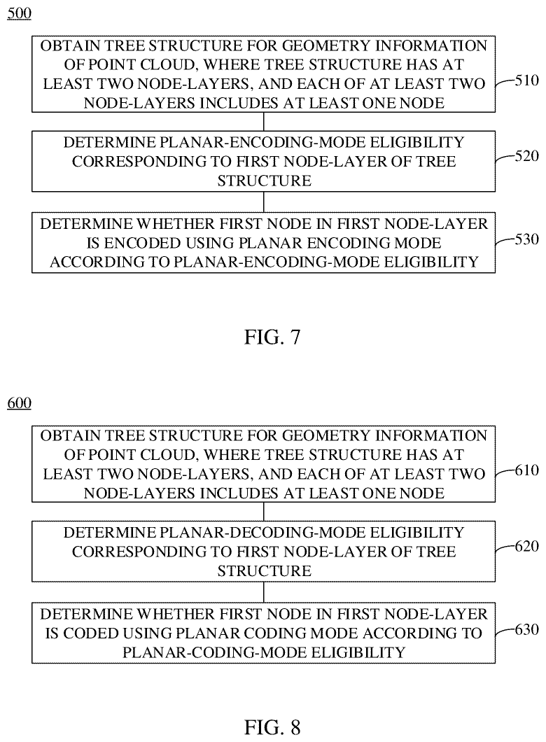

FIG. 7 is a schematic flowchart of an encoding method 500 provided in embodiments of the disclosure. The encoding method 500 is applicable to the encoder 100 illustrated in FIG. 3. For example, geometry information and attribute information of a point cloud may be input into the encoder 100, and thus compression encoding of the point cloud can be realized. As illustrated in FIG. 7, the method 500 includes operations at 510 to 530.

At 510, a tree structure for geometry information of a point cloud is obtained, where the tree structure has at least two node-layers, and each of the at least two node-layers includes at least one node.

Exemplarily, the tree structure may be an octree structure, which is not limited in the disclosure.

In some optional embodiments, a volumetric space corresponding to the point cloud may be split to obtain the tree structure, where the volumetric space corresponds to a root node of the tree structure, and sub-volumes split from the volumetric space correspond to nodes of the tree structure.

In some optional embodiments, the encoding end (such as the encoder) may transmit to the decoding end (such as the decoder) the number of points in the point cloud and related information of the tree structure (such as the octree structure) corresponding to the point cloud, for example, the number of layers and node information of each layer.

Specifically, for the tree structure and the splitting of the volumetric space for the point cloud, reference can be made to the description of FIG. 1, FIG. 2, or FIG. 5, which is not repeated herein.

At 520, planar-encoding-mode eligibility corresponding to a first node-layer of the tree structure is determined.

Exemplarily, the first node-layer may correspond to any node-layer of the octree structure in FIG. 5, such as the i-th layer of nodes or the (i+1)-th layer of nodes, and the planar-encoding-mode eligibility may be represented, for example, by planarEligibleKOctreeDepth. Exemplarily, for the first node-layer, reference can be made to the description of the node-layer of the octree structure in FIG. 5, and for the planar-encoding-mode eligibility, reference can be made to the description of planarEligibleKOctreeDepth in FIG. 5, which is not repeated herein.

In some optional embodiments, as a possible implementation for determining the planar-encoding-mode eligibility corresponding to the first node-layer of the tree structure, when the first node-layer is the first layer of nodes of the tree structure, the planar-encoding-mode eligibility corresponding to the first node-layer may be initialized. Exemplarily, for the (i=0)-th node-layer of the octree structure, the corresponding planarEligibleKOctreeDepth may be initialized as 0. Exemplarily, reference can be made to the description of the operations at 302 in FIG. 5, which is not repeated herein.

In some optional embodiments, as a possible implementation for determining the planar-encoding-mode eligibility corresponding to the first node-layer of the tree structure, a point cloud density of the first node-layer may be determined, and the planar-encoding-mode eligibility for the first node-layer may be determined according to the point cloud density of the first node-layer. Exemplarily, for the (i=1, 2, 3 . . . )-th node-layer of the octree structure, the planar-encoding-mode eligibility for the node-layer may be determined according to the point cloud density of the node-layer. Exemplarily, taking the operations at 303 to 319 in FIG. 5 as examples, planarEligibleKOctreeDepth of the (i+1)-th layer can be determined.

In some optional embodiments, as a possible implementation for determining the point cloud density of the first node-layer, the number of points for which a point location direct-encoding-mode is used may be determined in node-layers prior to the first node-layer in the point cloud. Furthermore, the first number of occupied child nodes corresponding to a previous node-layer of the first node-layer is determined, where the first number of occupied child nodes is the total number of occupied child nodes of a node(s) that is encoded using an occupancy bit encoding mode in the previous node-layer. Then, the point cloud density of the first node-layer is determined according to the number of points in the point cloud, the number of points for which the point location direct-encoding-mode is used, and the first number of occupied child nodes. Exemplarily, taking the operations at 303 to 316 in FIG. 5 as examples, realDensity, i.e., the point cloud density, of the (i+1)-th layer can be determined.

The node-layers prior to the first node-layer may include all node-layers prior to the first node-layer. For example, when the first node-layer is the 3rd layer of nodes, the node-layers prior to the first node-layer include the 0-th layer, the 1st layer, and the 2nd layer. In this case, the previous node-layer of the first node-layer is the 2nd layer of nodes.

It may be noted that, for determining realDensity of the i-th layer, the first number of occupied child nodes is the total number of occupied child nodes of a node(s) that is encoded using the occupancy bit encoding mode in the (i−1)-th layer of nodes, and for example, may be numSubnodes upon proceeding to the (i−1)-th layer of the octree.

In some optional embodiments, when a node(s) in the first node-layer is encoded using the point location direct-encoding-mode, a value of the number of points for which the point location direct-encoding-mode is used may be updated. Exemplarily, the node(s) for which the point location direct-encoding-mode is used herein includes an encoded node that proceeds to the planar encoding mode in the first node-layer (such as a node that satisfies the determining condition at 309 after executing the operations at 308 in FIG. 5) and an encoded node that does not proceed to the planar encoding mode (such as a node that does not satisfy the determining condition at 306 or 307 and satisfies the determining condition at 309 in FIG. 5), which is not limited in the disclosure. Exemplarily, the number of points for which the point location direct-encoding-mode is used may be represented by numPointsCodedByIdcm, and for details, reference can be made to the description of FIG. 5.

Exemplarily, taking the operations at 309 to 311 in FIG. 5 as examples, numPointsCodedByIdem in the point cloud can be updated.

Optionally, before the node in the first layer of nodes of the tree structure is encoded, the number of points for which the point location direct-encoding-mode is used is initialized. Exemplarily, taking the operations at 302 in FIG. 5 as examples, numPointsCodedByIdcm can be initialized as 0.

In some optional embodiments, when a node(s) in the first node-layer is encoded using the occupancy bit encoding mode, the second number of occupied child nodes corresponding to the first node-layer is updated, where the second number of occupied child nodes is the number of occupied child nodes of a node(s) that is encoded using the occupancy bit encoding mode in the first node-layer. Exemplarily, the node(s) for which the occupancy bit encoding mode is used herein includes an encoded node that proceeds to the planar encoding mode in the first node-layer (such as a node that does not satisfy the determining condition at 309 after executing the operations at 308 in FIG. 5) and an encoded node that does not proceed to the planar encoding mode (such as a node that does not satisfy the determining condition at 306 or 307 and does not satisfy the determining condition at 309 in FIG. 5), which is not limited in the disclosure.

It may be noted that, the second number of occupied child nodes is the total number of occupied child nodes of a node(s) that is encoded using the occupancy bit encoding mode in the i-th layer of nodes, and for example, may be numSubnodes upon proceeding to the i-th layer of the octree. Optionally, the second number of occupied child nodes can be used to determine realDensity of the (i+1)-th layer.

Optionally, before the node in the first node-layer is encoded, the second number of occupied child nodes is initialized. Exemplarily, taking the operations at 304 in FIG. 5 as examples, numSubnodes of the i-th layer can be initialized as 0.

In some optional embodiments, as a possible implementation for determining the planar-encoding-mode eligibility for the first node-layer according to the point cloud density of the first node-layer, if the point cloud density is less than a preset threshold, it is determined that the planar-encoding-mode eligibility indicates to encode the first node using the planar encoding mode. For example, at 318 in FIG. 5, the value of planarEligibleKOctreeDepth may be set to 1, i.e., planarEligibleKOctreeDepth=1, which means that the first node can be encoded using the planar encoding mode. If the point cloud density is greater than or equal to a preset threshold, it is determined that the planar-encoding-mode eligibility indicates not to encode the first node using the planar encoding mode. For example, at 319 in FIG. 5, the value of planarEligibleKOctreeDepth may be set to 0, i.e., planarEligibleKOctreeDepth=0, which means that the first node cannot be encoded using the planar encoding mode.

In some optional embodiments, the preset threshold is greater than or equal to 1. For example, in FIG. 5, the preset threshold is set to 1.3.

At 530, whether the first node in the first node-layer is encoded using the planar encoding mode is determined according to the planar-encoding-mode eligibility.

In some optional embodiments, it is determined that the first node is encoded using the planar encoding mode in a direction of a k-th axis, when the planar-encoding-mode eligibility indicates to encode the first node using the planar encoding mode and the first node satisfies at least one of the following conditions: the planar encoding mode is enabled for the first node, the k-th axis of an occupancy tree node corresponding to the first node is encoded, or the first node is a non-leaf node, where k is 0, 1, or 2.

Exemplarily, PlanarEligible [k]=1 may indicate that the first node is encoded using the planar encoding mode in the direction of the k-th axis. Exemplarily, taking the operations at 306 and 307 in FIG. 5 as examples, the value of PlanarEligible [k] may be determined according to the value of planarEligibleKOctreeDepth and whether “the planar encoding mode is enabled & the k-th axis of the occupancy tree node is encoded & the node is a non-leaf node”, and then whether the j-th node is encoded using the planar encoding mode in the direction of the k-th axis is determined according to the value of PlanarEligible [k]. When PlanarEligible [k]=1, the j-th node is encoded using the planar encoding mode in the direction of the k-th axis.

Therefore, in embodiments of the disclosure, planar-encoding-mode eligibility corresponding to a node-layer of the tree structure for the geometry information of the point cloud is determined, and then whether a node (such as a first node) in the node-layer is encoded using the planar encoding mode is determined according to the planar-encoding-mode eligibility corresponding to the node-layer. In embodiments of the disclosure, by determining the planar-encoding-mode eligibility corresponding to the node-layer of the tree structure corresponding to the geometry information of the point cloud, the planar-encoding-mode eligibility does not need to be determined for each node of the tree structure, thereby reducing computation complexity of coding and also improving encoding gains.

FIG. 8 is a schematic flowchart of a decoding method 600 provided in embodiments of the disclosure. The decoding method 600 is applicable to the decoder 200 illustrated in FIG. 4. For example, a geometry bitstream and attribute bitstream of a point cloud may be input into the decoder 200, and thus the point cloud can be decoded. As illustrated in FIG. 8, the method 600 includes operations at 610 to 630.

At 610, a tree structure for geometry information of a point cloud is obtained, where the tree structure has at least two node-layers, and each of the at least two node-layers includes at least one node.

Exemplarily, the tree structure may be an octree structure, which is not limited in the disclosure.

In some optional embodiments, the number of points in the point cloud and related information of the tree structure (such as the octree structure) corresponding to the point cloud, such as the number of layers and node information of each layer, may be obtained from the encoding end (such as the encoder). Therefore, the tree structure corresponding to the geometry information of the point cloud, such as an octree structure, can be obtained.

Specifically, for the tree structure, reference can be made to the description of FIG. 1, FIG. 2, or FIG. 5, which is not repeated herein.

At 620, planar-decoding-mode eligibility corresponding to a first node-layer of the tree structure is determined.

Exemplarily, the first node-layer may correspond to any node-layer of the octree structure in FIG. 6, such as the i-th layer of nodes or the (i+1)-th layer of nodes, and the planar-decoding-mode eligibility may be represented, for example, by planarEligibleKOctreeDepth. Exemplarily, for the first node-layer, reference can be made to the description of the node-layer of the octree structure in FIG. 6, and for the planar-decoding-mode eligibility, reference can be made to the description of planarEligibleKOctreeDepth in FIG. 6, which is not repeated herein.

In some optional embodiments, as a possible implementation for determining the planar-decoding-mode eligibility corresponding to the first node-layer of the tree structure, when the first node-layer is the first layer of nodes of the tree structure, the planar-decoding-mode eligibility corresponding to the first node-layer may be initialized. Exemplarily, for the (i=0)-th node-layer of the octree structure, the corresponding planarEligibleKOctreeDepth may be initialized as 0. Exemplarily, reference can be made to the description of the operations at 402 in FIG. 6, which is not repeated herein.

In some optional embodiments, as a possible implementation for determining the planar-decoding-mode eligibility corresponding to the first node-layer of the tree structure, a point cloud density of the first node-layer may be determined, and the planar-decoding-mode eligibility for the first node-layer may be determined according to the point cloud density of the first node-layer. Exemplarily, for the (i=1, 2, 3 . . . )-th node-layer of the octree structure, the planar-decoding-mode eligibility for the node-layer may be determined according to the point cloud density of the node-layer. Exemplarily, taking the operations at 403 to 419 in FIG. 6 as examples, planarEligibleKOctreeDepth of the (i+1)-th layer can be determined.

In some optional embodiments, as a possible implementation for determining the point cloud density of the first node-layer, the number of points for which a point location direct-decoding-mode is used may be determined in node-layers prior to the first node-layer in the point cloud. Furthermore, the first number of occupied child nodes corresponding to a previous node-layer of the first node-layer is determined, where the first number of occupied child nodes is the total number of occupied child nodes of a node(s) that is decoded using an occupancy bit decoding mode in the previous node-layer. Then, the point cloud density of the first node-layer is determined according to the number of points in the point cloud, the number of points for which the point location direct-decoding-mode is used, and the first number of occupied child nodes. Exemplarily, taking the operations at 403 to 416 in FIG. 6 as examples, realDensity, i.e., the point cloud density, of the (i+1)-th layer can be determined.

The node-layers prior to the first node-layer may include all node-layers prior to the first node-layer. For example, when the first node-layer is the 3rd layer of nodes, the node-layers prior to the first node-layer include the 0-th layer, the 1st layer, and the 2nd layer. In this case, the previous node-layer of the first node-layer is the 2nd layer of nodes.

It may be noted that, for determining realDensity of the i-th layer, the first number of occupied child nodes is the total number of occupied child nodes of a node(s) that is decoded using the occupancy bit decoding mode in the (i−1)-th layer of nodes, and for example, may be numSubnodes upon proceeding to the (i−1)-th layer of the octree.

In some optional embodiments, when a node(s) in the first node-layer is decoded using the point location direct-decoding-mode, a value of the number of points for which the point location direct-decoding-mode is used may be updated. Exemplarily, the node(s) for which the point location direct-decoding-mode is used herein includes a decoded node that proceeds to the planar decoding mode in the first node-layer (such as a node that satisfies the determining condition at 409 after executing the operations at 408 in FIG. 6) and a decoded node that does not proceed to the planar decoding mode (such as a node that does not satisfy the determining condition at 406 or 407 and satisfies the determining condition at 409 in FIG. 6), which is not limited in the disclosure. Exemplarily, the number of points for which the point location direct-decoding-mode is used may be represented by numPointsCodedByIdcm, and for details, reference can be made to the description of FIG. 6.

Exemplarily, taking the operations at 409 to 411 in FIG. 6 as examples, numPointsCodedByIdem in the point cloud can be updated.

Optionally, before the node in the first layer of nodes of the tree structure is decoded, the number of points for which the point location direct-decoding-mode is used is initialized. Exemplarily, taking the operations at 402 in FIG. 6 as examples, numPointsCodedByIdem can be initialized as 0.

In some optional embodiments, when a node(s) in the first node-layer is decoded using the occupancy bit decoding mode, the second number of occupied child nodes corresponding to the first node-layer is updated, where the second number of occupied child nodes is the number of occupied child nodes of a node(s) that is decoded using the occupancy bit decoding mode in the first node-layer. Exemplarily, the node(s) for which the occupancy bit decoding mode is used herein includes a decoded node that proceeds to the planar decoding mode in the first node-layer (such as a node that does not satisfy the determining condition at 409 after executing the operations at 408 in FIG. 6) and a decoded node that does not proceed to the planar decoding mode (such as a node that does not satisfy the determining condition at 406 or 407 and does not satisfy the determining condition at 409 in FIG. 6), which is not limited in the disclosure.

It may be noted that, the second number of occupied child nodes is the total number of occupied child nodes of a node(s) that is decoded using the occupancy bit decoding mode in the i-th layer of nodes, and for example, may be numSubnodes upon proceeding to the i-th layer of the octree. Optionally, the second number of occupied child nodes can be used to determine realDensity of the (i+1)-th layer.

Optionally, before the node in the first node-layer is decoded, the second number of occupied child nodes is initialized. Exemplarily, taking the operations at 404 in FIG. 6 as examples, numSubnodes of the i-th layer can be initialized as 0.

In some optional embodiments, as a possible implementation for determining the planar-decoding-mode eligibility for the first node-layer according to the point cloud density of the first node-layer, if the point cloud density is less than a preset threshold, it is determined that the planar-decoding-mode eligibility indicates to decode the first node using the planar decoding mode. For example, at 418 in FIG. 6, the value of planarEligibleKOctreeDepth may be set to 1, i.e., planarEligibleKOctreeDepth=1, which means that the first node can be decoded using the planar decoding mode. If the point cloud density is greater than or equal to a preset threshold, it is determined that the planar-decoding-mode eligibility indicates not to decode the first node using the planar decoding mode. For example, at 419 in FIG. 6, the value of planarEligibleKOctreeDepth may be set to 0, i.e., planarEligibleKOctreeDepth=0, which means that the first node cannot be decoded using the planar decoding mode.

In some optional embodiments, the preset threshold is greater than or equal to 1. For example, in FIG. 6, the preset threshold is set to 1.3.

At 630, whether the first node in the first node-layer is decoded using the planar decoding mode is determined according to the planar-decoding-mode eligibility.

In some optional embodiments, it is determined that the first node is decoded using the planar decoding mode in a direction of a k-th axis, when the planar-decoding-mode eligibility indicates to decode the first node using the planar decoding mode and the first node satisfies at least one of the following conditions: the planar decoding mode is enabled for the first node, the k-th axis of an occupancy tree node corresponding to the first node is decoded, or the first node is a non-leaf node, where k is 0, 1, or 2.

Exemplarily, PlanarEligible [k]=1 may indicate that the first node is decoded using the planar decoding mode in the direction of the k-th axis. Exemplarily, taking the operations at 406 and 407 in FIG. 6 as examples, the value of PlanarEligible [k] may be determined according to the value of planarEligibleKOctreeDepth and whether “the planar decoding mode is enabled & the k-th axis of the occupancy tree node is decoded & the node is a non-leaf node”, and then whether the j-th node is decoded using the planar decoding mode in the direction of the k-th axis is determined according to the value of PlanarEligible [k]. When PlanarEligible [k]=1, the j-th node is decoded using the planar decoding mode in the direction of the k-th axis.

Therefore, in embodiments of the disclosure, planar-decoding-mode eligibility corresponding to a node-layer of the tree structure for the geometry information of the point cloud is determined, and then whether a node (such as a first node) in the node-layer is decoded using the planar decoding mode is determined according to the planar-decoding-mode eligibility corresponding to the node-layer. In embodiments of the disclosure, by determining the planar-decoding-mode eligibility corresponding to the node-layer of the tree structure corresponding to the geometry information of the point cloud, the planar-decoding-mode eligibility does not need to be determined for each node of the tree structure, thereby reducing computation complexity of coding and also improving decoding gains.

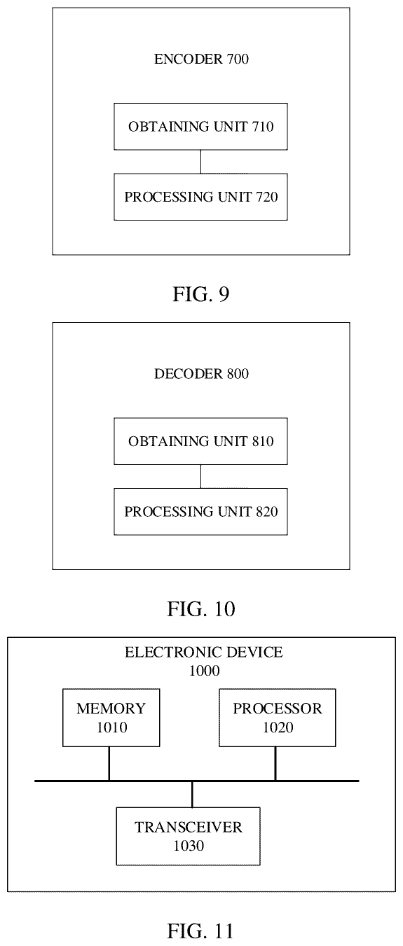

The method embodiments of the disclosure are described in detail above with reference to FIG. 5 to FIG. 8, and the apparatus embodiments of the disclosure will be described in detail below with reference to FIG. 9 to FIG. 11.

FIG. 9 is a schematic block diagram of an encoder 700 according to embodiments of the disclosure. For example, the encoder 700 may be the encoder in FIG. 3. As illustrated in FIG. 9, the encoder 700 may include an obtaining unit 710 and a processing unit 720.

The obtaining unit 710 is configured to obtain a tree structure for geometry information of a point cloud, where the tree structure has at least two node-layers, and each of the at least two node-layers includes at least one node. The processing unit 720 is configured to determine planar-encoding-mode eligibility corresponding to a first node-layer of the tree structure. The processing unit 720 is further configured to determine, according to the planar-encoding-mode eligibility, whether a first node in the first node-layer is encoded using a planar encoding mode.

Optionally, the processing unit 720 is specifically configured to determine a point cloud density of the first node-layer, and determine the planar-encoding-mode eligibility for the first node-layer according to the point cloud density of the first node-layer.

Optionally, the processing unit 720 is specifically configured to determine, in node-layers prior to the first node-layer in the point cloud, the number of points for which a point location direct-encoding-mode is used. The processing unit 720 is further configured to determine the first number of occupied child nodes corresponding to a previous node-layer of the first node-layer, where the first number of occupied child nodes is the total number of occupied child nodes of a node that is encoded using an occupancy bit encoding mode in the previous node-layer. The processing unit 720 is further configured to determine the point cloud density of the first node-layer according to the number of points in the point cloud, the number of points for which the point location direct-encoding-mode is used, and the first number of occupied child nodes.

Optionally, the processing unit 720 is further configured to update a value of the number of points for which the point location direct-encoding-mode is used, when a node in the first node-layer is encoded using the point location direct-encoding-mode.

Optionally, the processing unit 720 is further configured to initialize the number of points for which the point location direct-encoding-mode is used, before node(s) of the tree structure is encoded.

Optionally, the processing unit 720 is further configured to update the second number of occupied child nodes corresponding to the first node-layer when a node in the first node-layer is encoded using the occupancy bit encoding mode, where the second number of occupied child nodes is the number of occupied child nodes of a node that is encoded using the occupancy bit encoding mode in the first node-layer.

Optionally, the processing unit 720 is further configured to initialize the second number of occupied child nodes, before the node in the first node-layer is encoded.

Optionally, the processing unit 720 is specifically configured to determine that the planar-encoding-mode eligibility indicates to encode the first node using the planar encoding mode when the point cloud density is less than a preset threshold, and determine that the planar-encoding-mode eligibility indicates not to encode the first node using the planar encoding mode when the point cloud density is greater than or equal to a preset threshold.

Optionally, the preset threshold is greater than or equal to 1.

Optionally, the processing unit 720 is specifically configured to determine that the first node is encoded using the planar encoding mode in a direction of a k-th axis, when the planar-encoding-mode eligibility indicates to encode the first node using the planar encoding mode and the first node satisfies at least one of the following conditions: the planar encoding mode is enabled for the first node; the k-th axis of an occupancy tree node corresponding to the first node is encoded; or the first node is a non-leaf node, where k is 0, 1, or 2.

Optionally, the processing unit 720 is specifically configured to initialize the planar-encoding-mode eligibility corresponding to the first node-layer, when the first node-layer is the first layer of nodes of the tree structure.

Optionally, the obtaining unit 710 is specifically configured to split a volumetric space corresponding to the point cloud to obtain the tree structure, where the volumetric space corresponds to a root node of the tree structure, and sub-volumes split from the volumetric space correspond to nodes of the tree structure.

Optionally, the tree structure includes an octree structure.

It may be understood that the apparatus embodiments and the method embodiments may correspond to each other, and for similar descriptions, reference can be made to the method embodiments. To avoid repetition, details are not repeated herein. Specifically, the encoder 700 illustrated in FIG. 9 may correspond to a corresponding entity for implementing the method 300 or 500 in embodiments of the disclosure, and the above and other operations and/or functions of various modules of the encoder 700 are respectively intended for implementing corresponding operations in the method illustrated in FIG. 5 or FIG. 7, which will not be repeated herein for the sake of simplicity.

FIG. 10 is a schematic block diagram of a decoder 800 according to embodiments of the disclosure. For example, the decoder 800 may be the decoder in FIG. 4. As illustrated in FIG. 10, the decoder 800 may include an obtaining unit 810 and a processing unit 820.

The obtaining unit 810 is configured to obtain a tree structure for geometry information of a point cloud, where the tree structure has at least two node-layers, and each of the at least two node-layers includes at least one node. The processing unit 820 is configured to determine planar-decoding-mode eligibility corresponding to a first node-layer of the tree structure. The processing unit 820 is further configured to determine, according to the planar-decoding-mode eligibility, whether a first node in the first node-layer is decoded using a planar decoding mode.

Optionally, the processing unit 820 is specifically configured to determine a point cloud density of the first node-layer, and determine the planar-decoding-mode eligibility for the first node-layer according to the point cloud density of the first node-layer.

Optionally, the processing unit 820 is specifically configured to determine, in node-layers prior to the first node-layer in the point cloud, the number of points for which a point location direct-decoding-mode is used. The processing unit 820 is further configured to determine the first number of occupied child nodes corresponding to a previous node-layer of the first node-layer, where the first number of occupied child nodes is the total number of occupied child nodes of a node that is decoded using an occupancy bit decoding mode in the previous node-layer. The processing unit 820 is further configured to determine the point cloud density of the first node-layer according to the number of points in the point cloud, the number of points for which the point location direct-decoding-mode is used, and the first number of occupied child nodes.

Optionally, the processing unit 820 is further configured to update a value of the number of points for which the point location direct-decoding-mode is used, when a node in the first node-layer is decoded using the point location direct-decoding-mode.

Optionally, the processing unit 820 is further configured to initialize the number of points for which the point location direct-decoding-mode is used, before the node in first layer of nodes of the tree structure is decoded.

Optionally, the processing unit 820 is further configured to update the second number of occupied child nodes corresponding to the first node-layer when a node in the first node-layer is decoded using the occupancy bit decoding mode, where the second number of occupied child nodes is the number of occupied child nodes of a node that is decoded using the occupancy bit decoding mode in the first node-layer.

Optionally, the processing unit 820 is further configured to initialize the second number of occupied child nodes, before the node in the first node-layer is decoded.

Optionally, the processing unit 820 is specifically configured to determine that the planar-decoding-mode eligibility indicates to decode the first node using the planar decoding mode when the point cloud density is less than a preset threshold, and determine that the planar-decoding-mode eligibility indicates not to decode the first node using the planar decoding mode when the point cloud density is greater than or equal to a preset threshold.

Optionally, the preset threshold is greater than or equal to 1.

Optionally, the processing unit 820 is specifically configured to determine that the first node is decoded using the planar decoding mode in a direction of a k-th axis, when the planar-decoding-mode eligibility indicates to decode the first node using the planar decoding mode and the first node satisfies at least one of the following conditions: the planar decoding mode is enabled for the first node; the k-th axis of an occupancy tree node corresponding to the first node is decoded; or the first node is a non-leaf node, where k is 0, 1, or 2.

Optionally, the processing unit 820 is specifically configured to initialize the planar-decoding-mode eligibility corresponding to the first node-layer, when the first node-layer is the first layer of nodes of the tree structure.

Optionally, the tree structure includes an octree structure.

It may be understood that the apparatus embodiments and the method embodiments may correspond to each other, and for similar descriptions, reference can be made to the method embodiments. To avoid repetition, details are not repeated herein. Specifically, the decoder 800 illustrated in FIG. 10 may correspond to a corresponding entity for implementing the method 400 or 600 in embodiments of the disclosure, and the above and other operations and/or functions of various modules of the decoder 800 are respectively intended for implementing corresponding operations in the method illustrated in FIG. 6 or FIG. 8, which will not be repeated herein for the sake of simplicity.

The apparatus and system in embodiments of the disclosure have been described above from the perspective of functional modules with reference to the accompanying drawings. It may be understood that, the functional module may be implemented by the form of hardware, or may be implemented by an instruction in the form of software, or may be implemented by a combination of hardware and software modules. Specifically, each step of the method embodiments of the disclosure may be completed by an integrated logic circuit of hardware in a processor and/or an instruction in the form of software. The steps of the method disclosed in embodiments of the disclosure may be directly implemented by a hardware decoding processor, or may be performed by hardware and software modules in the decoding processor. Optionally, the software module can be located in a mature storage medium in the field such as a random access memory, a flash memory, a read-only memory, a programmable read-only memory, or an electrically erasable programmable memory, registers, and the like. The storage medium is located in a memory. The processor reads the information in the memory, and completes the steps of the foregoing method embodiments with the hardware of the processor.

FIG. 11 is a schematic block diagram of an electronic device 1000 provided in embodiments of the disclosure.

As illustrated in FIG. 11, the electronic device 1000 may include a memory 1010 and a processor 1020. The memory 1010 is configured to store a computer program and transmit the program codes to the processor 1020. In other words, the processor 1020 can invoke and run the computer program from the memory 1010 to implement the point cloud processing method in embodiments of the disclosure.

For example, the processor 1020 can be configured to execute the steps in any of the above-mentioned methods 300 to 600 according to the instructions in the computer program.

In some embodiments of the disclosure, the processor 1020 may include, but is not limited to: a general-purpose processor, digital signal processor (DSP), application specific integrated circuit (ASIC), field programmable gate array (FPGA), or other programmable logic devices, discrete gates or transistor logic devices, discrete hardware components, and so on.

In some embodiments of the disclosure, the memory 1010 includes but is not limited to: volatile memory and/or non-volatile memory. The non-volatile memory can be a read-only memory (ROM), programmable read-only memory (PROM), erasable PROM (EPROM), electrically EPROM (EEPROM), or flash memory. The volatile memory may be random access memory (RAM), which acts as an external cache. By way of illustration and not limitation, many forms of RAM are available such as static RAM (SRAM), dynamic RAM (DRAM), synchronous DRAM (SDRAM), double data rate synchronous dynamic random access memory (DDR SDRAM), enhanced synchronous dynamic random access memory (enhanced SDRAM, ESDRAM), synchronous connection dynamic random access memory (synch link DRAM, SLDRAM) and direct memory bus random access memory (direct rambus RAM, DR RAM).

In some embodiments of the disclosure, the computer program can be divided into one or more modules, and the one or more modules are stored in the memory 1010 and executed by the processor 1020 to complete the point processing methods in the present disclosure. The one or more modules may be a series of computer program instruction segments capable of accomplishing specific functions, and the instruction segments are used to describe the execution process of the computer program in the electronic device 1000.

Optionally, as illustrated in FIG. 11, the electronic device 1000 may also include a transceiver 1030, where the transceiver 1030 may be connected to the processor 1020 or the memory 1010.

The processor 1020 can control the transceiver 1030 to communicate with other devices, specifically, to send information or data to other devices, or receive information or data sent by other devices. The transceiver 1030 may include a transmitter and a receiver. The transceiver 1030 may further include antennas, and the number of antennas may be one or more.

It may be understood that the various components in the electronic device 1000 are connected through a bus system, where the bus system includes not only a data bus, but also a power bus, a control bus, and a status signal bus.

According to an aspect of the disclosure, a decoder is provided. The decoder includes a processor and a memory for storing a computer program. The processor is configured to invoke and run the computer program stored in the memory to cause the decoder to perform the methods of the above method embodiments.

According to an aspect of the disclosure, a computer storage medium is provided, on which a computer program is stored, and when the computer program is executed by a computer, the computer can execute the methods of the above method embodiments. In other words, embodiments of the disclosure further provide a computer program product including instructions, and when the instructions are executed by a computer, the computer executes the methods of the foregoing method embodiments.

According to another aspect of the disclosure, a computer program product or a computer program is provided. The computer program product or computer program includes computer instructions. The computer instructions are stored in a computer-readable storage medium. A processor of a computer device can read the computer instructions from the computer-readable storage medium and run the computer instructions to cause the computer device to perform the methods of the above method embodiments.

In other words, when implemented using software, the disclosure may be implemented in whole or in part in the form of a computer program product. The computer program product includes one or more computer instructions. When the computer program instructions are loaded and executed on the computer, the processes or functions according to the embodiments of the disclosure will be generated in whole or in part. The computer can be a general-purpose computer, a special-purpose computer, a computer network, or other programmable devices. The computer instructions may be stored in or transmitted from one computer-readable storage medium to another computer-readable storage medium, for example, the computer instructions may be transferred from a website, computer, server, or data center by wire (such as coaxial cable, optical fiber, digital subscriber line (DSL)) or wireless (such as infrared, wireless, microwave, etc.) to another website site, computer, server or data center. The computer-readable storage medium may be any available medium that can be accessed by a computer, or a data storage device such as a server or a data center integrated with one or more available media. The available medium may be a magnetic medium (such as a floppy disk, a hard disk, or a magnetic tape), an optical medium (such as a digital video disc (DVD)), or a semiconductor medium (such as a solid state disk (SSD)), etc.

Those skilled in the art can appreciate that the modules and algorithm steps of the examples described in conjunction with the embodiments disclosed herein can be implemented by electronic hardware, or a combination of computer software and electronic hardware. Whether these functions are executed by hardware or software depends on the specific disclosure and design constraints of the technical solution. Those skilled in the art may use different methods to implement the described functions for each specific disclosure, but such implementation may not be regarded as exceeding the scope of the present disclosure.

In the several embodiments provided in this disclosure, it may be understood that the disclosed systems, apparatuses, and methods may be implemented in other ways. For example, the apparatus embodiments described above are only illustrative. For example, the division of the modules is only a logical function division. In actual implementation, there may be other division methods. For example, multiple modules or components can be combined or can be integrated into another system, or some features may be ignored or skipped. In another point, the mutual coupling or direct coupling or communication connection illustrated or discussed may be through some interfaces, and the indirect coupling or communication connection of devices or modules may be in electrical, mechanical, or other forms.

A unit described as a separate component may or may not be physically separated, and a component displayed as a unit may or may not be a physical unit, that is, it may be located in one place, or may be distributed to multiple network units. Part or all of the units can be selected according to actual needs to achieve the purpose of the solution of this implementation. For example, each functional unit in each embodiment of the disclosure may be integrated into one processing unit, each unit may exist separately physically, or two or more units may be integrated into one unit.

The above is only a specific implementation of the disclosure, but the scope of protection of the disclosure is not limited thereto. Those skilled in the art can easily think of changes or substitutions within the technical scope disclosed in the disclosure, which may be covered within the scope of protection of this disclosure. Therefore, the protection scope of the present disclosure may be based on the protection scope of the claims.

What is claimed is:

1. An encoding method, comprising:
obtaining a tree structure for geometry information of a point cloud, wherein the tree structure has at least two node-layers, and each of the at least two node-layers comprises at least one node;
determining planar-encoding-mode eligibility corresponding to a first node-layer of the tree structure; and
determining, according to the planar-encoding-mode eligibility, whether a first node in the first node-layer is encoded using a planar encoding mode.

2. The method of claim 1, wherein determining the planar-encoding-mode eligibility corresponding to the first node-layer of the tree structure comprises:
determining a point cloud density of the first node-layer; and
determining the planar-encoding-mode eligibility for the first node-layer according to the point cloud density of the first node-layer.

3. The method of claim 2, wherein determining the point cloud density of the first node-layer comprises:
determining, in node-layers prior to the first node-layer in the point cloud, a number of points for which a point location direct-encoding-mode is used;
determining a first number of occupied child nodes corresponding to a previous node-layer of the first node-layer, wherein the first number of occupied child nodes is a total number of occupied child nodes of a node that is encoded using an occupancy bit encoding mode in the previous node-layer; and
determining the point cloud density of the first node-layer according to a number of points in the point cloud, the number of points for which the point location direct-encoding-mode is used, and the first number of occupied child nodes.

4. The method of claim 3, further comprising:
updating a value of the number of points for which the point location direct-encoding-mode is used, when a node in the first node-layer is encoded using the point location direct-encoding-mode.

5. The method of claim 4, further comprising:
initializing the number of points for which the point location direct-encoding-mode is used, before the node in the first layer of nodes of the tree structure is encoded.

6. The method of claim 3, further comprising:
updating a second number of occupied child nodes corresponding to the first node-layer, when a node in the first node-layer is encoded using the occupancy bit encoding mode, wherein the second number of occupied child nodes is a number of occupied child nodes of a node that is encoded using the occupancy bit encoding mode in the first node-layer.

7. The method of claim 6, further comprising:
initializing the second number of occupied child nodes, before the node in the first node-layer is encoded.

8. The method of claim 2, wherein determining the planar-encoding-mode eligibility for the first node-layer according to the point cloud density of the first node-layer comprises:
determining that the planar-encoding-mode eligibility indicates to encode the first node using the planar encoding mode, when the point cloud density is less than a preset threshold; and
determining that the planar-encoding-mode eligibility indicates not to encode the first node using the planar encoding mode, when the point cloud density is greater than or equal to a preset threshold.

9. The method of claim 8, wherein determining, according to the planar-encoding-mode eligibility, whether the first node in the first node-layer is encoded using the planar encoding mode comprises:
determining that the first node is encoded using the planar encoding mode in a direction of a k-th axis, when the planar-encoding-mode eligibility indicates to encode the first node using the planar encoding mode and the first node satisfies at least one of the following conditions:
the planar encoding mode is enabled for the first node;
the k-th axis of an occupancy tree node corresponding to the first node is encoded; or
the first node is a non-leaf node,
wherein k is 0, 1, or 2.

10. A decoding method, comprising:
obtaining a tree structure for geometry information of a point cloud, wherein the tree structure has at least two node-layers, and each of the at least two node-layers comprises at least one node;
determining planar-decoding-mode eligibility corresponding to a first node-layer of the tree structure; and
determining, according to the planar-decoding-mode eligibility, whether a first node in the first node-layer is decoded using a planar decoding mode.

11. The method of claim 10, wherein determining the planar-decoding-mode eligibility corresponding to the first node-layer of the tree structure comprises:
determining a point cloud density of the first node-layer; and
determining the planar-decoding-mode eligibility for the first node-layer according to the point cloud density of the first node-layer.

12. The method of claim 11, wherein determining the point cloud density of the first node-layer comprises:
determining, in node-layers prior to the first node-layer in the point cloud, a number of points for which a point location direct-decoding-mode is used;
determining a first number of occupied child nodes corresponding to a previous node-layer of the first node-layer, wherein the first number of occupied child nodes is a total number of occupied child nodes of a node that is decoded using an occupancy bit decoding mode in the previous node-layer; and
determining the point cloud density of the first node-layer according to a number of points in the point cloud, the number of points for which the point location direct-decoding-mode is used, and the first number of occupied child nodes.

13. The method of claim 12, further comprising:
updating a value of the number of points for which the point location direct-decoding-mode is used, when a node in the first node-layer is decoded using the point location direct-decoding-mode.

14. The method of claim 13, further comprising:
initializing the number of points for which the point location direct-decoding-mode is used, before the node in the first layer of nodes of the tree structure is decoded.

15. The method of claim 12, further comprising:
updating a second number of occupied child nodes corresponding to the first node-layer, when a node in the first node-layer is decoded using the occupancy bit decoding mode, wherein the second number of occupied child nodes is a number of occupied child nodes of a node that is decoded using the occupancy bit decoding mode in the first node-layer.

16. The method of claim 15, further comprising:
initializing the second number of occupied child nodes, before the node in the first node-layer is decoded.

17. The method of claim 11, wherein determining the planar-decoding-mode eligibility for the first node-layer according to the point cloud density of the first node-layer comprises:
determining that the planar-decoding-mode eligibility indicates to decode the first node using the planar decoding mode, when the point cloud density is less than a preset threshold; and
determining that the planar-decoding-mode eligibility indicates not to decode the first node using the planar decoding mode, when the point cloud density is greater than or equal to a preset threshold.

18. The method of claim 17, wherein determining, according to the planar-decoding-mode eligibility, whether the first node in the first node-layer is decoded using the planar decoding mode comprises:
determining that the first node is decoded using the planar decoding mode in a direction of a k-th axis, when the planar-decoding-mode eligibility indicates to decode the first node using the planar decoding mode and the first node satisfies at least one of the following conditions:
the planar decoding mode is enabled for the first node;
the k-th axis of an occupancy tree node corresponding to the first node is decoded; or
the first node is a non-leaf node,
wherein k is 0, 1, or 2.

19. The method of claim 10, wherein determining the planar-decoding-mode eligibility corresponding to the first node-layer of the tree structure comprises:
initializing the planar-decoding-mode eligibility corresponding to the first node-layer, when the first node-layer is the first layer of nodes of the tree structure.

20. The method of claim 10, wherein the tree structure comprises an octree structure.
